(19) United States
(12) Patent Application Publication
(10) Pub. No.: US 2026/0168194 A1
(43) Pub. Date: Jun. 18, 2026

(54) Modular Living Erosion Control System

(71) Applicant: Paul William Everett, Temecula, CA (US)

(72) Inventor: Paul William Everett, Temecula, CA (US)

(21) Appl. No.: 19/531,595

(22) Filed: Feb. 5, 2026

(51) Int. Cl. E02D 17/20; A01G 9/02

(52) U.S. Cl. CPC E02D 17/205; A01G 9/021

(57) ABSTRACT

A modular living erosion control and slope stabilization system is disclosed. The system comprises a plurality of discrete biodegradable containment units configured to be arranged along a surface subject to erosion. Each unit contains a growth-supporting medium and vegetative components and is deployable in a dry or dormant state. Upon exposure to moisture, the units support plant growth and establishment of root systems that extend into surrounding soil. The units initially provide mechanical stabilization and subsequently transition into a permanent living stabilization system through biological reinforcement of the soil.

### STATEMENT REGARDING FEDERALLY SPONSORED RESEARCH OR DEVELOPMENT

Not applicable.

### CROSS-REFERENCE TO RELATED APPLICATIONS

This application claims priority to and the benefit of the applicant's previously filed provisional application directed to modular living erosion control systems, the entire contents of which are incorporated herein by reference.

### BACKGROUND OF THE INVENTION

Erosion control and slope stabilization are critical challenges in construction, land development, and landscape restoration.

Conventional erosion control systems often rely on inert or temporary materials that provide limited long-term stability and do not integrate biological reinforcement.

There is a need for systems that provide immediate mechanical stabilization while transitioning into permanent, living stabilization through vegetation and root development.

### SUMMARY OF THE INVENTION

The present invention provides a modular living erosion control and slope stabilization system comprising discrete, biodegradable containment units configured to be arranged along a surface subject to erosion.

The units initially provide mechanical stabilization and transition over time into a permanent living system through establishment of vegetation and root-based soil reinforcement.

### BRIEF DESCRIPTION OF THE DRAWINGS

FIG. 1 illustrates a perspective view of a single modular erosion control unit.

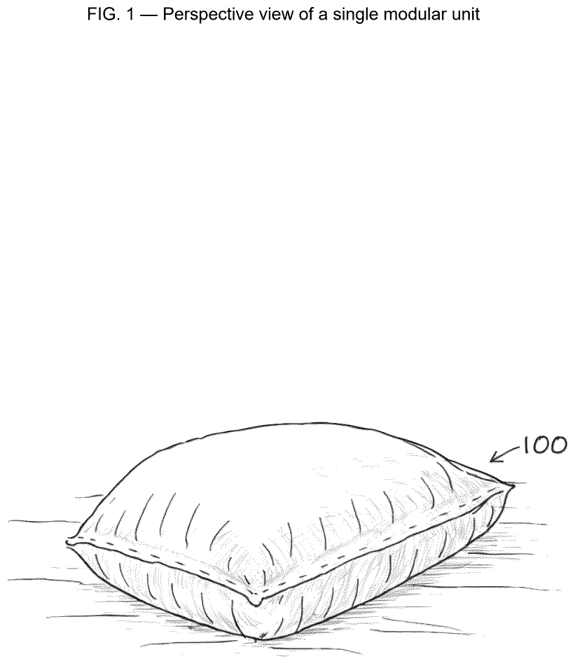

FIG. 2 illustrates a side view of multiple modular units arranged in a stacked configuration on a slope.

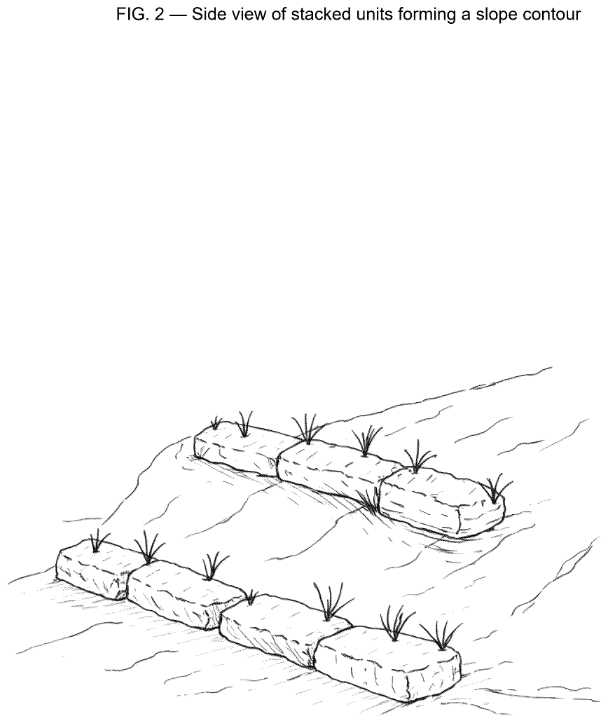

FIG. 3 illustrates a plan view of modular units arranged laterally across terrain contours.

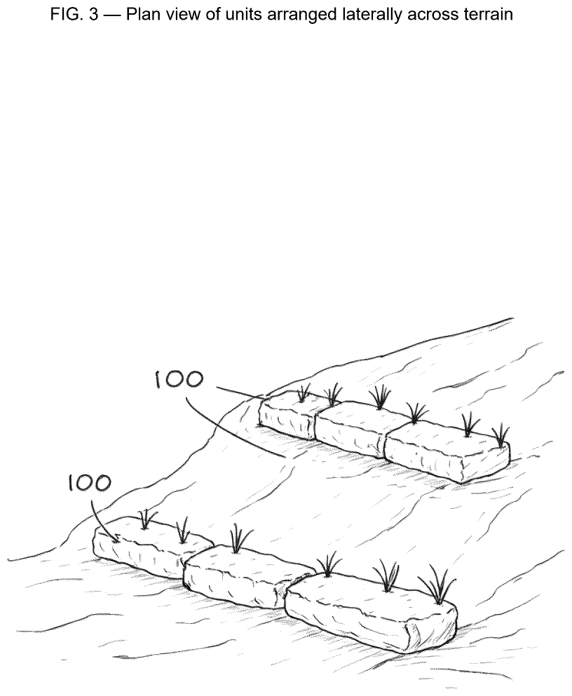

FIG. 4 illustrates a cross-sectional view showing interaction between a modular unit, surrounding soil, and plant emergence.

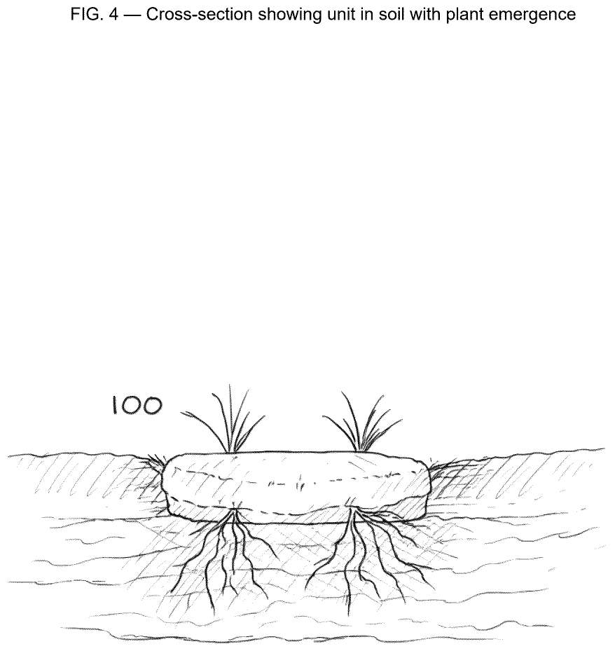

### DETAILED DESCRIPTION OF THE INVENTION

Referring to the drawings, each modular unit comprises a biodegradable outer containment defining a non-tubular geometry, a growth-supporting medium disposed within the containment, and one or more vegetative components.

The units are deployable in a dry or dormant state and activate upon exposure to moisture.

When arranged along a slope or terrain feature, the units function initially as gravity-based erosion control elements and subsequently transition into a permanent living landform stabilized by interconnected root systems as the containment biodegrades.

1. A modular living erosion control and slope stabilization system comprising:
a plurality of discrete containment units, each containment unit comprising a biodegradable outer containment defining a non-tubular geometry, a growth-supporting medium disposed within the containment, and one or more vegetative components configured to establish plant growth; wherein the containment units are configured to be arranged along a surface subject to erosion such that the units initially provide mechanical stabilization and subsequently transition into a permanent living stabilization system through plant growth and root development extending into surrounding soil.

2. The system of claim 1, wherein the containment units are stackable in overlapping or staggered configurations along a slope.

3. The system of claim 1, wherein the containment units are arranged to follow terrain contours.

4. The system of claim 1, wherein the biodegradable outer containment comprises burlap, jute, coir, or a biodegradable textile material.

5. The system of claim 1, wherein the growth-supporting medium comprises soil, compost, biochar, organic matter, or combinations thereof.

6. The system of claim 1, wherein the vegetative components comprise seeds, seedlings, cuttings, propagules, or dormant plant material.

7. The system of claim 1, wherein the containment units are deployable in a dry or dormant state and activate upon exposure to moisture.

8. A method of stabilizing a slope or erosion-prone surface, comprising:
deploying a plurality of modular containment units in a dry or dormant state along a surface subject to erosion; arranging the units in a stacked, chained, or contoured configuration; exposing the units to moisture to activate plant growth; and allowing plant roots to extend beyond the containment units into surrounding soil to provide biological stabilization.

9. The method of claim 8, wherein the containment units provide gravity-based stabilization prior to establishment of vegetation.

10. A constructed living landform comprising a plurality of biodegradable containment units arranged along a slope, wherein the units initially function as mechanical erosion control elements and transition into a permanently stabilized landform through establishment of interconnected plant root systems.

11. The system of claim 1, wherein at least one containment unit includes internal seams, stitched regions, partitions, or segmented zones.

12. The system of claim 1, wherein at least one containment unit has a length greater than its width while remaining a discrete, non-tubular module configured for stacked, overlapped, or contoured arrangement.
